(19) United States
(12) Patent Application Publication
(10) Pub. No.: US 2025/0202317 A1
(43) Pub. Date: Jun. 19, 2025

(54) ELECTRICAL MACHINE WITH OIL COOLING

(71) Applicant: Robert Bosch GmbH, Stuttgart (DE)

(72) Inventors: Aron Lenart, Budapest (HU); Heiko Jahn, Tamm (DE); Jannik Stammler, Stuttgart (DE); Tobias Harer, Tiefenborn (DE)

(21) Appl. No.: 18/987,284

(22) Filed: Dec. 19, 2024

(30) Foreign Application Priority Data
Dec. 19, 2023 (DE) 10 2023 212 919.1

(51) Int. Cl. H02K 9/19; H02K 7/00; H02K 24/00

(52) U.S. Cl. CPC H02K 9/19; H02K 7/003; H02K 24/00

(57) ABSTRACT

An electrical machine includes a rotor with a rotor shaft that is hollow at least in sections, which is mounted on a machine housing and extends along an axial direction. A coolant connection line module has a fluid inlet nozzle and a fluid outlet nozzle, with the fluid inlet nozzle fluidically connected to a coolant channel of the machine housing. The fluid outlet nozzle projects in the axial direction into the hollow rotor shaft. The coolant connection line module has an outlet mounting section that is different from the fluid inlet nozzle and the fluid outlet nozzle and is arranged closer to the fluid outlet nozzle than to the fluid inlet nozzle, and is attached to the machine housing via the outlet mounting section at least in the axial direction.

### BACKGROUND

The present invention relates to an electrical machine. The electrical machine has a rotor with a hollow shaft and a coolant connection line module for introducing coolant into the shaft.

Various types of coolant connection modules are known from the prior art, which are designed to spray cooling fluid such as oil. Such modules are described, for example, in the documents CA 2 788 386 A1, US 2015 027388 A1, KR 1998 0029811 A, US 2018 126405 A1 and KR 2005 0058676 A.

### SUMMARY

The electrical machine has a rotor, wherein the rotor comprises a rotor shaft that is hollow at least in sections. The rotor shaft is mounted on a machine housing and extends along an axial direction. Furthermore, a coolant connection line module is provided with a fluid inlet nozzle and a fluid outlet nozzle. The fluid outlet nozzle projects in the axial direction into the hollow rotor shaft. The fluid inlet nozzle is fluidically connected with a coolant channel of the machine housing.

The coolant connection line module has an outlet mounting section that is different from the fluid inlet nozzle and the fluid outlet nozzle. This outlet mounting section is arranged closer to the fluid outlet nozzle than to the fluid inlet nozzle. The coolant connection line module is attached to the machine housing via the outlet mounting section, at least in the axial direction.

The outlet mounting section enables the reliable fixing of the entire coolant connection line module on the one hand, but especially of the fluid outlet nozzle inside the rotor shaft. The fluid outlet nozzle thus only has to project a shortened distance into the hollow rotor shaft. The material of the coolant connection line module is therefore particularly cheaper and can therefore be designed to be less stable, since additional stability is achieved by the outlet mounting section. The entire coolant connection line module can thus be produced more easily and at lower cost than previously possible with the prior art. Furthermore, the fluid outlet nozzle in particular can be precisely aligned in the hollow rotor shaft.

The coolant connection line module preferably has an inlet mounting section that is different from the fluid inlet nozzle and the fluid outlet nozzle. The inlet mounting section is arranged closer to the fluid inlet nozzle than to the fluid outlet nozzle. In particular, the fluid inlet nozzle has a bearing foot with a screw passage. According to the invention, the fluid outlet nozzle is designed, preferably via said bearing foot with screw passage, for fastening the coolant connection line module to the machine housing. Thus, the coolant connection line module is attached to the machine housing at two points. On the one hand, it is advantageously connected to the outlet mounting section, and on the other hand, preferably to the inlet mounting section. The coolant connection line module is therefore optimally attached to the machine housing on the one hand, and on the other hand, optimally aligned with the machine housing. This allows, in particular, the use of less stable and less expensive materials. By dividing the connection of the coolant connection line module to the machine housing into the inlet mounting section and the outlet mounting section, the coolant connection line module can be optimally fixed near the relevant fluid transfer points.

It is particularly advantageous that mounting elements are formed on the inlet mounting section. The mounting elements are used for attaching cables of a cable harness of the electrical machine. The coolant connection line module thus fulfills an additional function, namely holding cables on the machine housing. Additional fastening components on the machine housing for holding and/or guiding cables are therefore avoided. Thus, the number of required parts is reduced compared to the prior art. In particular, such mounting elements are formed integrally with the inlet mounting section.

The outlet mounting section advantageously has at least one latching element. The latching element is used to produce a latching connection, whereby the coolant connection line module is fixed axially. The axial fixing means that, in particular, the removal of the coolant connection line module in the axial direction away from the rotor shaft is prevented. Thus, in particular, the fluid outlet nozzle is optimally arranged within the hollow rotor shaft. The latching connection is easy to produce, and in particular the latching connection is made independently by inserting the fluid outlet nozzle into the rotor shaft. It is particularly advantageous if the latching element is designed as a flexible snap-fit hook or similar, which engages behind an edge to make the latching connection. The outlet mounting section preferably has at least two fastening elements, such as latching elements. The latching elements are arranged in particular around the fluid outlet nozzle. This means in particular that the latching elements are located on an arc around the fluid outlet nozzle. The latching elements extend in particular in a U-shaped manner as a spring arm in the axial direction. It is preferably provided that the latching elements engage behind the machine housing or a component attached to the machine housing. In this way, a reliable latching connection is established, wherein the fluid outlet nozzle is optimally fixed. Thus, the fluid outlet nozzle can protrude into the hollow rotor shaft as the free end of the coolant connection line module. Both an alignment and a fixation of the fluid outlet nozzle are ensured by the latching elements.

The fluid inlet nozzle is preferably inserted into the coolant channel of the machine housing. Furthermore, it is envisaged that the fluid inlet nozzle rests against a wall of the coolant channel, in particular by means of a seal. The contact with the wall of the coolant channel preferably fulfills a sealing effect, which is why the seal is advantageously provided. In a particularly advantageous embodiment, the fluid inlet nozzle is not fixed within the coolant channel, except for the frictional connection necessary for the sealing effect. A form fit and/or a screw connection preferably does not take place. Rather, the fluid inlet nozzle is fixed within the coolant channel by the coolant connection line module being attached to the machine housing. The inlet mounting section described is particularly advantageous for this purpose, as it connects the coolant connection line module to the machine housing in the vicinity of the fluid inlet nozzle. It is not necessary to attach the fluid inlet nozzle directly to the coolant channel, for example using a central screw with a hollow screw body.

In an advantageous embodiment, the coolant connection line module is designed in one piece. In particular, the coolant connection line module is manufactured by gas injection molding. Thus, the manufacturing process is simple and cost-effective, wherein a cost-effective material can also be used. Injection molding with gas injection makes it easy and cost-effective to produce a wide variety of shapes for the coolant connection line module. The coolant connection line module can thus be easily and inexpensively adapted to the specific conditions at the place of use, in particular to the embodiment of the electrical machine. In particular, a coolant channel is produced by the gas injection. The coolant channel extends between the fluid inlet and the fluid outlet. The one-piece embodiments of the coolant connection line module ensures that the channel for the coolant is sealed, thus minimizing the risk of an unwanted leakage of the coolant.

In an alternative embodiment, the coolant connection line module is preferably designed in several parts. In this case, the coolant connection line module has a lower part and an upper part. The fluid inlet nozzle and/or fluid outlet nozzle and/or inlet mounting section and/or outlet mounting section are formed on the lower part. The upper part is attached to the lower part and serves in particular as a lid. A fluid conduit channel is formed between the upper part and the lower part in order to transport fluid from the fluid inlet nozzle to the fluid outlet nozzle. The multi-part design simplifies production. In particular, gas injection or similar processes can be dispensed with. The individual parts, i.e. the upper part and the lower part, are preferably designed without undercuts and can thus be optimally produced by injection molding or other casting processes.

In particular, the upper part and the lower part each have a groove-shaped cavity. The groove-shaped cavity serves to conduct the coolant. When the upper part and the lower part are fastened together, the respective groove-shaped cavities together preferably form a cooling channel for conducting the coolant. Furthermore, it is particularly advantageous that the upper part and the lower part each have a shoulder adjacent to the groove-shaped cavity on both sides. The shoulder is used to join the upper parts and lower parts. The joining process is preferably carried out via a substance-to-substance bond, in particular by welding. Joining in this way ensures in particular that the channel formed by the groove-shaped cavities is sealed, thus minimizing the risk of the coolant leaking out unintentionally.

The lower part and the upper part are advantageously centered with respect to one another. This is preferably done by at least one bore of the lower part, into which a pin of the upper part is inserted. Alternatively or additionally, the upper part has a bore into which a pin of the lower part is inserted. This allows the upper part and the lower part to be easily and reliably centered relative to each other. This reliably enables the cooling channel to be formed by the upper parts and lower parts. The centering also allows the upper parts and lower parts to be optimally joined, making it possible to fasten the two parts easily and with little effort.

The upper part and the lower part are advantageously each designed in one piece. In particular, it is envisaged that the lower part and the upper part are manufactured by injection molding.

In an advantageous embodiment, the coolant connection line module is made of plastic. In particular, the coolant connection line module does not have to be able to withstand high fluid pressures, which is why the plastic design is possible in a simple and cost-effective manner. The use of plastic also preferably results in reduced material costs for the coolant connection line module.

The electrical machine preferably has a resolver stator for determining an orientation of the rotor shaft. The resolver stator annularly surrounds the rotor shaft, in particular at one end of the rotor shaft, particularly advantageously at the B-side of the electrical machine. The resolver stator is also attached to the machine housing, in particular by screwing. According to the invention, the outlet mounting section of the coolant connection line module is attached to the resolver stator. The outlet mounting section is particularly advantageously attached to the resolver stator by means of a latching connection. This attachment can be carried out particularly advantageously before the resolver stator is mounted, so that the resolver stator and the coolant connection line module can be mounted together. This simplifies the assembly of the electrical machine. In particular, individual elements of the electrical machine can be preassembled, making the entire assembly process simpler, more flexible and faster.

The coolant connection line module preferably has an additional outlet for dispensing cooling fluid in addition to the fluid outlet nozzle. The additional outlet is particularly advantageous when it is arranged closer to the fluid outlet nozzle than to the fluid inlet nozzle. The additional outlet can supply additional areas with cooling fluid, for example, fill a reservoir by free jet.

The coolant is particularly advantageous if it is an oil. The oil is fed through the hollow rotor shaft and used in particular to cool the rotor and/or a winding of the stator.

### BRIEF DESCRIPTION OF THE DRAWINGS

In the following, exemplary embodiment of the invention are described in detail with reference to the accompanying drawings. The drawings show:

FIG. 1 a schematic view of an electrical machine according to an exemplary embodiment of the invention,

FIG. 2 a schematic detailed view of the electrical machine according to the exemplary embodiment of the invention, in particular a coolant connection line module of the electrical machine,

FIG. 3 a schematic sectional view through a part of the electrical machine, in particular through the coolant connection line module,

FIG. 4 a schematic illustration of the electrical machine's coolant connection line module according to the exemplary embodiment of the invention,

FIG. 5a a schematic illustration of a cable harness of the electrical machine according to the exemplary embodiment of the invention,

FIG. 5b a schematic illustration of the pre-assembly of the cable harness and the coolant connection line module of the electrical machine according to the exemplary embodiment of the invention, and

FIG. 6 a schematic detailed illustration of the electrical machine according to the exemplary embodiment of the invention.

### DETAILED DESCRIPTION

Preferably, all identical components, elements, and/or units are provided with the same reference symbols in all figures.

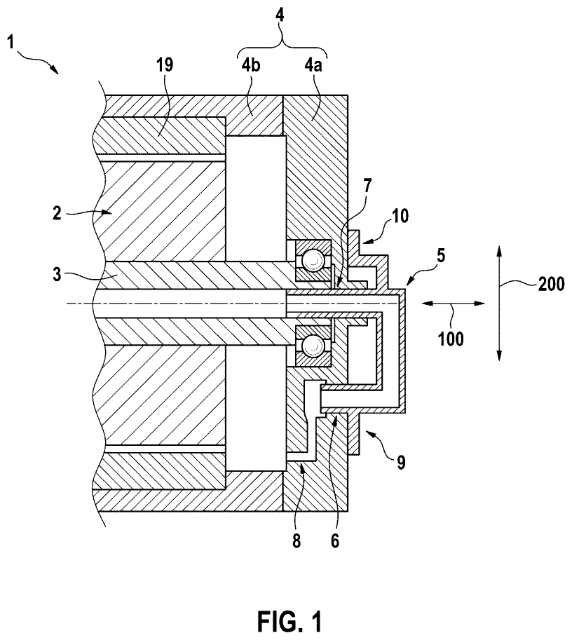

FIG. 1 schematically shows an electrical machine 1 according to an exemplary embodiment of the invention. The electrical machine 1 has a rotor 2 that can be driven by a stator 19. The rotor 2 has a hollow rotor shaft 3, at least in sections. The rotor shaft 3 extends along an axial direction 100 and is mounted on a machine housing 4. FIG. 1 shows that the rotor shaft 3 is mounted on an end shield 4a. The stator 19 is also attached to the machine housing 4, for example to a pot-shaped housing part 4b. The end shield 4a and other housing parts 4b will be collectively referred to as the machine housing 4 in the following.

The machine housing 4, in particular the bearing plate 4a, has a coolant channel 8. Via a coolant connection line module 5, the coolant can be directed from the coolant channel 8 of the machine housing 4 into the hollow rotor shaft 3. For this purpose, the coolant connection line module 5 has a fluid inlet nozzle 6 and a fluid outlet nozzle 7, wherein a coolant channel extending at least partially along a radial direction 200 is provided in the coolant connection line module 5 between the fluid inlet nozzle 6 and the fluid outlet nozzle 7.

The fluid inlet nozzle 6 is inserted into the coolant channel 8 of the machine housing. The fluid outlet nozzle 7 projects in the axial direction 100 into the hollow rotor shaft 3. In particular, the coolant connection line module 5 is not fixed and aligned by means of the fluid inlet nozzle 6 and/or fluid outlet nozzle 7, but by means of at least one inlet mounting section 9 and outlet mounting section 10, which are different from the fluid inlet nozzle 6 and the fluid outlet nozzle 7. The inlet mounting section 9 is arranged closer to the fluid inlet nozzle 6 than to the fluid outlet nozzle 7. The outlet mounting section 10 is arranged closer to the fluid outlet nozzle 7 than to the fluid inlet nozzle 6.

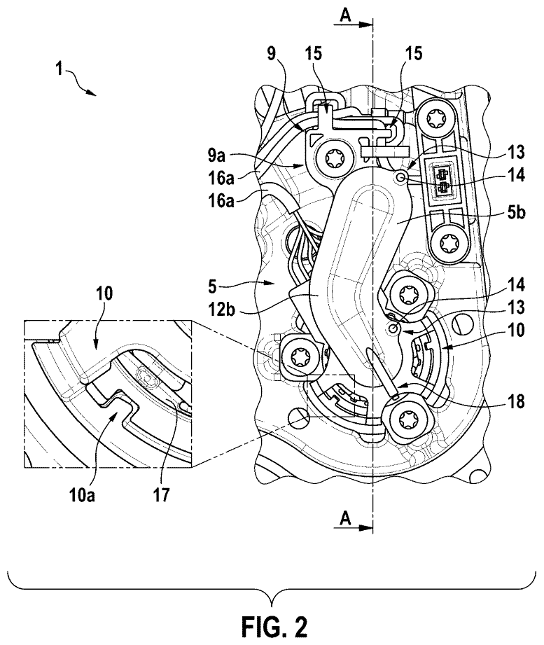

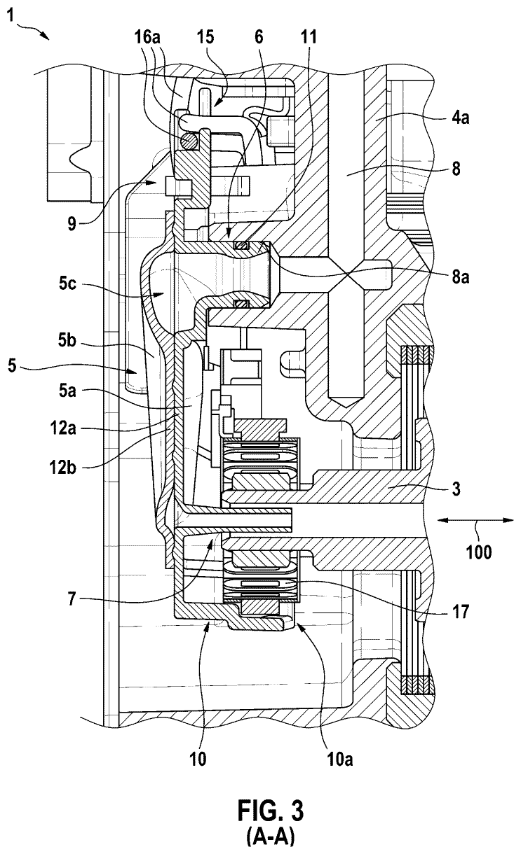

FIG. 2 schematically shows a partial view of the electrical machine 1, wherein in particular the coolant connection line module 5 is shown. FIG. 3 schematically shows a sectional view through a partial area of the electrical machine 1, wherein in particular the coolant connection line module 5 is shown in section. The section is made at the section line A: A as shown in FIG. 2.

In the shown exemplary embodiment, the coolant connection line module 5 is designed in several parts. A lower part 5a and an upper part 5b attached to the lower part 5a are provided. The fluid inlet nozzle 6, the fluid outlet nozzle 7, the inlet mounting section 9 and the outlet mounting section 10 are formed on the lower part 5a. The lower part 5a is designed in one piece. In particular, the lower part 5a can be produced by injection molding and preferably has no undercuts. Similarly, the upper part 5b can preferably be produced by injection molding and also has no undercuts.

The lower part 5a and the upper part 5b preferably each have a groove-shaped cavity 5c that serves to conduct the coolant. In addition, adjoining shoulders 12a, 12b are provided on both sides of the groove-shaped cavity 5c. These shoulders 12a, 12b serve to join the upper part 5b and the lower part 5a. The joining is carried out via a substance-to-substance bond, particularly advantageously by welding. This ensures that the coolant cannot escape from the groove-shaped cavity 5c.

The inlet mounting section 9 preferably has a bearing foot with a screw passage 9a. The inlet mounting section 9 and thus the coolant connection line module 5 can be attached to the machine housing 4 via this bearing foot with screw passage 9a. In particular, the fluid inlet nozzle 6 is not attached directly. Rather, it is merely intended that the fluid inlet nozzle 6 rests against an opening 8a of the coolant channel 8 in order to create a seal. In addition, a seal 11 is particularly advantageously provided for improving the seal between the fluid inlet nozzle 6 and the coolant channel 8. In particular, no screw connection and/or interlocking connection between the fluid inlet nozzle 6 and the coolant channel 8 is provided.

The coolant connection line module 5 is also fixed to the machine housing 4 by the outlet mounting section 10. For this purpose, the outlet mounting section 10 has at least one latching element 10a for establishing a latching connection that enables a form fit at least in the axial direction 100.

The said latching connection of the outlet mounting section 10 is achieved by a plurality of latching elements 10a, wherein the latching elements 10a are arranged in an arc around the fluid outlet nozzle 7. Each latching element 10a extends as a U-shaped spring arm in the axial direction 100 and engages behind a resolver stator 17. The resolver stator 17 is provided to determine an orientation of the rotor shaft 3 and annularly surrounds the rotor shaft 3. The resolver stator 17 is attached to the machine housing 4 by means of several screws. When the resolver stator 17 is attached to the machine housing 4, the coolant connection line module 5 is also attached to the machine housing 4. The outlet mounting section 10 and thus the coolant connection line module 5 can be easily and reliably attached to the resolver stator 17 by means of the latching elements 10a of the outlet mounting section 10. In particular, this allows for pre-assembly of the coolant connection line module 5 on the resolver stator 17. This enables joint assembly of the coolant connection line module 5 and resolver stator 17. Mounting the outlet mounting section 10 on the resolver stator 17 also engages the fluid outlet nozzle 7 in the hollow rotor shaft 3. The fluid outlet nozzle 7 is aligned with the rotor shaft 3 at the same time as the resolver stator 17 is aligned with the rotor shaft 3. In particular, this makes it easy to center the fluid outlet nozzle with little effort.

The inlet mounting section 9 is designed as a mounting foot with a screw passage 9a for attaching the inlet mounting section 9 to the machine housing 4 by means of a screw. In addition, the inlet mounting section 9 has mounting elements 15 for attaching cables 16a of a cable harness 16 of the electrical machine 1. The cables 16a can thus be attached to and/or routed through the coolant connection line module 5.

In order to center the upper part 5b and the lower part 5a, in the illustrated exemplary embodiment the upper part 5b has two bores 13. A pin 14 of the lower part 5a engages in each bore 13. This ensures that the upper part 5b and the lower part 5a are aligned relative to one another.

The upper part 5b also has an additional outlet 18. The additional outlet 18 is used to dispense the cooling fluid in addition to the fluid outlet nozzle 7. This means that cooling fluid can be supplied to another location. For example, the additional outlet 18 can be used to fill a reservoir with a free jet.

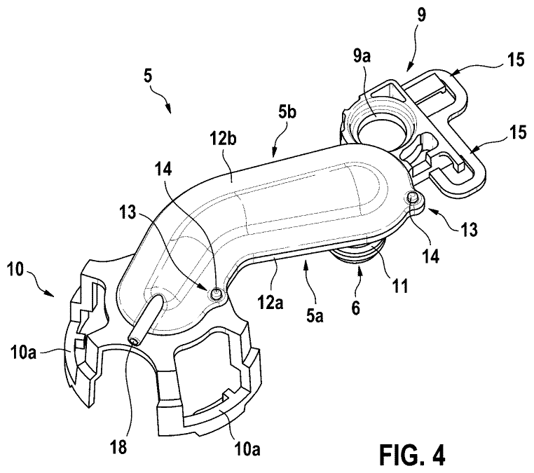

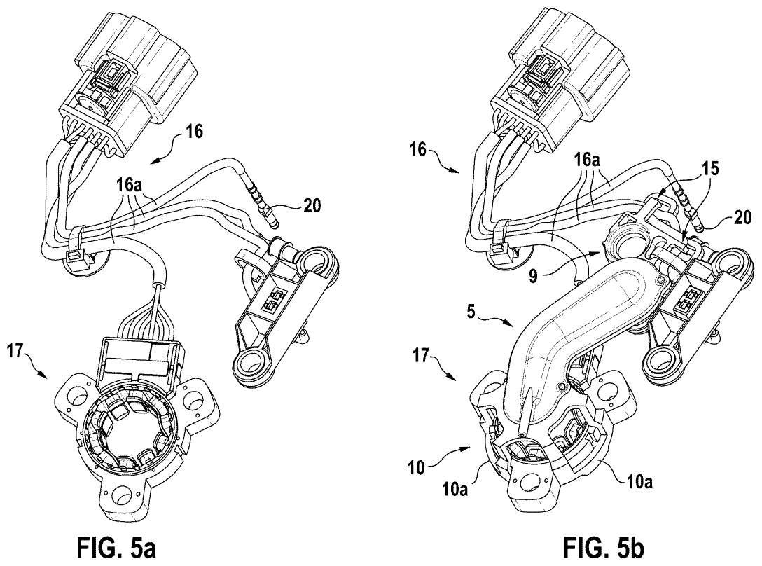

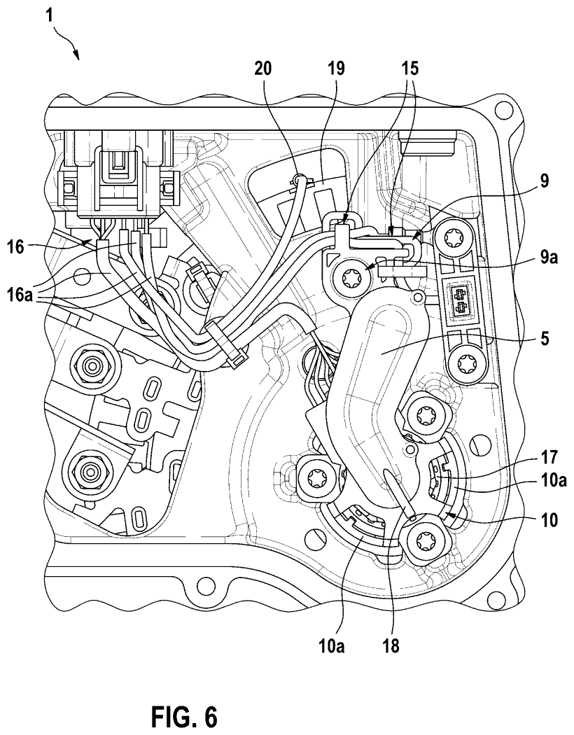

FIG. 4 schematically shows the coolant connection line module 5. FIG. 5a schematically shows a cable harness 16 of the electrical machine 1. The cable harness 16 has several cables 16a which, in particular, contact the resolver stator 17 and a temperature sensor 20. In order to simplify the production and assembly of the electrical machine 1, the cable harness 16 and the coolant connection line module 5 are designed to be preassembled. This is shown in FIG. 5b. In this case, on the one hand, the outlet mounting section 10 is attached to the resolver stator 17 by means of the latching elements 10a. In addition, cables 16a of the cable harness 16 are routed to the coolant connection line module 5 and, in particular, held by means of the mounting elements 15 of the inlet mounting section 9. In a further step, the cable harness 16 can thus be mounted together with the coolant connection line module 5 on the electrical machine 1. This state is shown in FIG. 6. In particular, the temperature sensor 20 is attached to the stator 19 or in the vicinity of the stator 19 in order to detect its temperature. The resolver stator 17 is attached to the machine housing 4, whereby the coolant connection line module 5 is also attached to the machine housing 4, wherein the fluid outlet nozzle 7 projects in the axial direction 100 into the hollow rotor shaft 3.

In the exemplary embodiment shown, the coolant connection line module 5 is preferably made of plastic, in particular in several parts by injection molding individual parts. Alternatively, the coolant connection line module 5 can also be manufactured in one piece, in particular by gas injection molding. In all cases, the coolant connection line module 5 can be manufactured easily and at low cost. The manufacturing costs for the coolant connection line module 5 are minimized. In addition, the coolant connection line module 5 can take on additional tasks, such as fastening and guiding cables 16a of the cable harness 16. In particular, it is assembled together with the resolver stator 17. On the one hand, this means that additional components, such as additional cable routings for the cables 16a, are not necessary, and on the other hand, the assembly of the electrical machine is simplified.

1. An electrical machine (1) comprising:
a rotor (2) with a rotor shaft (3) that is hollow at least in sections, which is mounted on a machine housing (4) and extends along an axial direction (100),
a coolant connection line module (5) with a fluid inlet nozzle (6) and a fluid outlet nozzle (7),
wherein the fluid inlet nozzle (6) is fluidically connected to a coolant channel (8) of the machine housing (4),
wherein the fluid outlet nozzle (7) projects in the axial direction (100) into the hollow rotor shaft (3), and
wherein the coolant connection line module (5) has an outlet mounting section (10) that is different from the fluid inlet nozzle (6) and the fluid outlet nozzle (7) and is arranged closer to the fluid outlet nozzle (7) than to the fluid inlet nozzle (6), and wherein the coolant connection line module (5) is attached to the machine housing (4) via the outlet mounting section (10) at least in the axial direction (100).

2. The electrical machine (1) according to claim 1, wherein the coolant connection line module (5) has an inlet mounting section (9) that is different from the fluid inlet nozzle (6) and the fluid outlet nozzle (7), and which is arranged closer to the fluid inlet nozzle (6) than to the fluid outlet nozzle (7).

3. The electrical machine (1) according to claim 2, wherein mounting elements (15) for attaching cables (16a) of a cable harness (16) of the electrical machine (1) are formed on the inlet mounting section (9).

4. The electrical machine (1) according to claim 1, wherein the outlet mounting section (10) has at least one latching element (10a) for establishing a latching connection for fixing the coolant connection line module (5) at least in the axial direction (100).

5. The electrical machine (1) according to claim 4, wherein the outlet mounting section (10) has at least two latching elements (10a) which:
are arranged around the fluid outlet nozzle (7),
each extend as a spring arm in the axial direction (100), and
engage behind the machine housing (4) or a component attached to the machine housing (4).

6. The electrical machine (1) according to claim 1, wherein the fluid inlet nozzle (6) is inserted into the coolant channel (8) of the machine housing (4) and rests against a wall (8a) of the coolant channel (8).

7. The electrical machine (1) according to claim 1, wherein the coolant connection line module (5) is configured in one piece.

8. The electrical machine (1) according to claim 2, wherein the coolant connection line module (5) is configured in multiple parts and has a lower part (5a) on which the fluid inlet nozzle (6) and/or the fluid outlet nozzle (7) and/or the inlet mounting section (9) and/or the outlet mounting section (10) are formed, and an upper part (5b) attached to the lower part (5a).

9. The electrical machine (1) according to claim 8, wherein the upper part (5b) and the lower part (5a) each have a groove-shaped cavity (5c) for conducting the coolant and each have a shoulder (12a, 12b) adjoining the groove-shaped cavity (5c) on both sides, for joining the upper part (5b) and the lower part (5a).

10. The electrical machine (1) according to claim 8, wherein the lower part (5a) and the upper part (5b) are centered with respect to one another.

11. The electrical machine (1) according to claim 8, wherein the lower part (5a) and the upper part (5b) are each configured in one piece.

12. The electrical machine (1) according to claim 1, wherein the coolant connection line module (5) is made of plastic.

13. The electrical machine (1) according to claim 1, wherein the electrical machine (1) has a resolver stator (17) for determining an orientation of the rotor shaft (3),
wherein the resolver stator (17) annularly surrounds the rotor shaft (3),
wherein the resolver stator (17) is attached to the machine housing (4), and
wherein the outlet mounting section (10) of the coolant connection line module (5) is attached to the resolver stator (17).

14. The electrical machine (1) according to claim 1, wherein the coolant connection line module (5) has an additional outlet (18) for dispensing cooling fluid in addition to the fluid outlet nozzle (7).

15. The electrical machine (1) according to claim 2, wherein the inlet mounting section (9) has a bearing foot with a screw passage (9a) for fastening to the machine housing (4).

16. The electrical machine (1) according to claim 5, wherein the spring arm is a U-shaped spring arm.

17. The electrical machine (1) according to claim 6, wherein a seal (11) is provided between the fluid inlet nozzle (6) and the wall (8a) of the coolant channel (8).

18. The electrical machine (1) according to claim 7, wherein the coolant connection line module (5) is manufactured by injection molding with gas injection.

19. The electrical machine (1) according to claim 10, wherein the lower part (5a) and the upper part (5b) are centered with respect to one another by at least one bore (13) of the lower part (5a), into which a pin (14) of the upper part (5b) is inserted, and/or by at least one bore (13) of the upper part (5b), into which a pin (14) of the lower part (5a) is inserted.

20. The electrical machine (1) according to claim 11, wherein the lower part (5a) and the upper part (5b) are manufactured by injection molding.
